(19) United States
(12) Patent Application Publication
(10) Pub. No.: US 2019/0011013 A1
(43) Pub. Date: Jan. 10, 2019

(54) ACTIVE VIBRATION DAMPER FOR A VEHICLE DRIVELINE COMPONENT

(71) Applicant: GM Global Technology Operations LLC, Detroit, MI (US)

(72) Inventors: Scott C. Mrdeza, Lennon, MI (US); Xiaofeng Mao, Novi, MI (US); Hai Xu, Northville, MI (US); Jeffrey N. Heaton, White Lake, MI (US)

(21) Appl. No.: 15/644,052

(22) Filed: Jul. 7, 2017

(51) Int. Cl. F16F 15/16; B60K 17/22; F16F 15/124; F16F 15/167; F16F 15/126; F16F 7/108; F16F 7/10

(52) U.S. Cl. CPC F16F 15/161; B60K 17/22; F16F 15/1245; F16F 15/167; F16F 15/126; F16F 7/108; F16H 37/0813; F16F 2224/045; F16F 2230/18; F16F 2222/06; F16F 2222/12; F16F 2232/02; F16F 2234/02; F16F 7/1017

(57) ABSTRACT

A system includes a vibration damper coupled for rotation with a rotating body. The vibration damper includes one or more fluid pockets. A reactive fluid is arranged in the one or more fluid pockets. The reactive fluid is configured to undergo a property change upon being exposed to a selected force. A force producing mechanism is fixedly mounted relative to the vibration damper, the force producing mechanism being operable to selectively produce the selected force.

### INTRODUCTION

The subject disclosure relates to vibration dampers and, more particularly, to an active vibration damper for a motor vehicle.

Mechanical systems may be subjected to vibration during operation. In particular, mechanical systems that employ rotating components such as engines, or that include rotating gears, such as vehicles and the like, may be subjected to various vibrational frequencies. For example, vehicles typically include a prime mover that may take the form of an electric motor, a hybrid motor, or an internal combustion motor. The prime mover, in operation, may produce vibrations at one or more frequencies.

The prime mover typically provides power to a transmission. The transmission, in turn, transfers power from the prime mover to, for example, a differential assembly. The power is typically transferred from the engine to the differential through a drive or propshaft. Rotation of the driveshaft may produce undesirable vibrations and/or noise. Specifically, the vibrations produced by the mechanical system may generate undesirable noise and/or vibration. The undesirable noise or vibration may lead to premature fatigue of associated components. The undesirable noise and vibrations may occur across multiple frequencies or may change from one frequency to another based on driving conditions. Current driveshaft vibration dampers are tuned to a specific frequency. That frequency may not attenuate vibrations in other frequencies. Accordingly, it is desirable to provide for tunable vibration damper for driveshaft applications.

### SUMMARY

In accordance with an aspect of an exemplary embodiment, a system includes a vibration damper coupled for rotation with a rotating body. The vibration damper includes one or more fluid pockets. A reactive fluid is arranged in the one or more fluid pockets. The reactive fluid is configured to undergo a property change upon being exposed to a selected force. A force producing mechanism is fixedly mounted relative to the vibration damper, the force producing mechanism being operable to selectively produce the selected force.

In addition to one or more of the features described above or below, or as an alternative, further embodiments could include wherein the one or more fluid pockets comprises a plurality of discrete fluid pockets.

In addition to one or more of the features described above or below, or as an alternative, further embodiments could include wherein the plurality of discrete fluid pockets are arranged in an annular array about the vibration damper.

In addition to one or more of the features described above or below, or as an alternative, further embodiments could include wherein the vibration damper includes a first portion formed out of a first material, a second portion formed out of a second material, and a third portion formed from a third material, the second material being distinct from at least one of the first material and the third material.

In addition to one or more of the features described above or below, or as an alternative, further embodiments could include wherein the second portion is disposed between the first portion and the third portion.

In addition to one or more of the features described above or below, or as an alternative, further embodiments could include wherein the second material is distinct from each of the first material and the third material.

In addition to one or more of the features described above or below, or as an alternative, further embodiments could include wherein the first material is the same as the third material.

In addition to one or more of the features described above or below, or as an alternative, further embodiments could include wherein the second material comprises an elastomeric material.

In addition to one or more of the features described above or below, or as an alternative, further embodiments could include wherein the reactive fluid comprises a magnetorheological fluid.

In addition to one or more of the features described above or below, or as an alternative, further embodiments could include wherein the force producing mechanism comprises an electromagnet.

In accordance with another aspect of an exemplary embodiment, a vehicle includes a frame, a transmission, a differential assembly, a driveshaft mechanically connecting the transmission and the differential assembly, and a vibration damper coupled for rotation with the driveshaft. The vibration damper includes one or more fluid pockets. A reactive fluid is arranged in the one or more fluid pockets. The reactive fluid is configured to undergo a property change upon being exposed to a selected force. A force producing mechanism is fixedly mounted relative to the vibration damper, the force producing mechanism being operable to selectively produce the selected force.

In addition to one or more of the features described above or below, or as an alternative, further embodiments could include wherein the one or more fluid pockets comprises a plurality of discrete fluid pockets.

In addition to one or more of the features described above or below, or as an alternative, further embodiments could include wherein the plurality of discrete fluid pockets are arranged in an annular array about the vibration damper.

In addition to one or more of the features described above or below, or as an alternative, further embodiments could include wherein the vibration damper includes a first portion formed out of a first material, a second portion formed out of a second material, and a third portion formed from a third material, the second material being distinct from at least one of the first material and the third material.

In addition to one or more of the features described above or below, or as an alternative, further embodiments could include wherein the second portion is disposed between the first portion and the third portion.

In addition to one or more of the features described above or below, or as an alternative, further embodiments could include wherein the second material is distinct from each of the first material and the third material.

In addition to one or more of the features described above or below, or as an alternative, further embodiments could include wherein the first material is the same as the third material.

In addition to one or more of the features described above or below, or as an alternative, further embodiments could include wherein the second material comprises an elastomeric material.

In addition to one or more of the features described above or below, or as an alternative, further embodiments could include wherein the reactive fluid comprises a magnetorheological fluid.

In addition to one or more of the features described above or below, or as an alternative, further embodiments could include wherein the force producing mechanism comprises an electromagnet.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is partial view of a rear of a vehicle including an active vibration damper mounted to a driveshaft, in accordance with an exemplary embodiment;

FIG. 2 is partial cross-sectional view of the active vibration damper of FIG. 1, in accordance with an aspect of an exemplary embodiment; and

FIG. 3 is a partial disassembled view of the active vibration damper of FIG. 1, in accordance with an aspect of an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

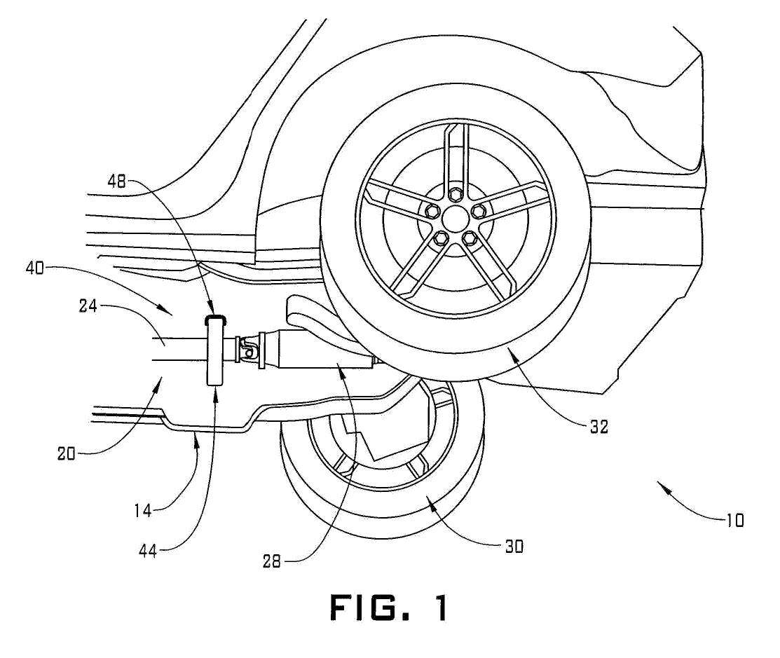

A vehicle, in accordance with an exemplary embodiment, is illustrated generally at 10 in FIG. 1. Vehicle 10 includes a frame 14 that supports a driveline or drivetrain, a portion of which is indicated at 20. Drivetrain 20 includes a drive shaft 24 mechanically connected to a differential 28 which, in turn, is mechanically connected to a first wheel 30 and a second wheel 32 through corresponding first and second axles (not shown). In operation, differential 28 may generate undesirable noise and/or vibrations. Similarly, drive shaft 24 may generate undesirable noise and/or vibrations. In order to reduce undesirable noise and/or vibrations vehicle 10 includes an active vibration damper system 40 associated with driveshaft 24.

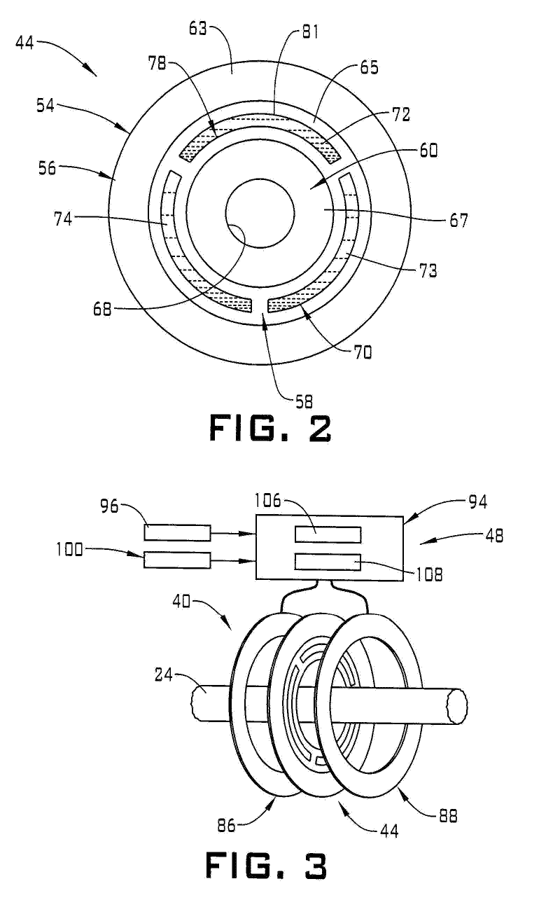

In accordance with an aspect of an exemplary embodiment, active vibration damper system 40 includes an active vibration damper 44 and a force producing mechanism 48. As shown in FIG. 2, active vibration damper 44 includes a body 54 having a first portion 56, a second portion 58 and a third portion 60. Second portion 58 is arranged radially inwardly of first portion 56 and third portion 60 is arranged radially inwardly of second portion 58. In accordance with an exemplary aspect, first portion 56 is formed from a first material 63, second portion 58 is formed from a second material 65 and third portion 60 is formed from a third material 67. First material 63 and third material 67 may be a metal. Further, first material 63 and third material 67 may be similar materials. Of course, it should be understood that first and third materials 63 and 67 could be different. Second material 65 may be an elastomeric material such as rubber. Additionally, third portion 60 includes a central opening 68 that may be receptive of driveshaft 24.

In further accordance with an exemplary aspect, second portion 58 includes one or more fluid pockets 70 arranged in an annular array about body 54. Fluid pockets 70 may take the form of a plurality of discrete fluid pockets including, for example, a first fluid pocket 72, a second fluid pocket 73, and a third fluid pocket 74. The number of fluid pockets can vary. Each fluid pocket 72, 73, and 74 may be filled with a reactive fluid 78. Reactive fluid 78 may undergo a state change in response to exposure to an activating force provided by force producing mechanism 48. In an embodiment, reactive fluid 78 may take the form of a magnetorheological (MR) fluid 81 that may change viscosity in response to being exposed to a magnetic field.

In still further accordance with an exemplary aspect, force producing mechanism 48 is fixedly mounted relative to frame 14 and may take the form of an electromagnet system including a first electromagnet 86 and a second electromagnet 88 as shown in FIG. 3. First and second electromagnets 86 and 88 may be operatively connected to a vibration controller 94 and a vibration sensor 96. First and second electromagnets 86 and 88 may also be coupled to a power source 100 that provides activation energy. Power source 100 may comprise a battery associated with force producing mechanism 48 or may take the form of a vehicle battery (not shown).

In an embodiment, vibration controller 94 includes a central processor unit (CPU) 106 and a non-volatile memory 108. Vibration controller 94 may selectively activate first and/or second electromagnets 86 and 88 in response to a vibration in driveshaft 24 sensed by vibration sensor 96. Further, vibration controller 94 may selectively activate first and/or second electromagnets 86 and 88 based on a tuning table stored in non-volatile memory 108. That is, vibration controller 94 may determine a vibration type, such as for example vibrations associated with high speed operation, vibrations associated with low speed operation, vibrations associated with accelerations and/or decelerations and make a selected tuning adjustment based on values stored in a look-up table in non-volatile memory 108. For example, magnetic field strength of one, the other, or both of first and second electromagnets 86 and 88 may be controlled to provide a selected damping at active vibration damper 44 in order to attenuate vibrations produced by driveshaft 24.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the exemplary embodiments not be limited to the particular embodiments disclosed, but will include all embodiments falling within the scope of the application.

What is claimed is:

1. A system comprising:
a vibration damper coupled for rotation with a rotating body, the vibration damper including one or more fluid pockets;
a reactive fluid arranged in the one or more fluid pockets, the reactive fluid being configured to undergo a property change upon being exposed to a selected force; and
a force producing mechanism fixedly mounted relative to the vibration damper, the force producing mechanism being operable to selectively produce the selected force.

2. The system according to claim 1, wherein the one or more fluid pockets comprises a plurality of discrete fluid pockets.

3. The system according to claim 2, wherein the plurality of discrete fluid pockets are arranged in an annular array about the vibration damper.

4. The system according to claim 2, wherein the vibration damper includes a first portion formed out of a first material, a second portion formed out of a second material, and a third portion formed from a third material, the second material being distinct from at least one of the first material and the third material.

5. The system according to claim 4, wherein the second portion is disposed between the first portion and the third portion.

6. The system according to claim 4, wherein the second material is distinct from each of the first material and the third material.

7. The system according to claim 4, wherein the first material is the same as the third material.

8. The system according to claim 4, wherein the second material comprises an elastomeric material.

9. The system according to claim 1, wherein the reactive fluid comprises a magnetorheological fluid.

10. The system according to claim 9, wherein the force producing mechanism comprises an electromagnet.

11. A vehicle comprising:
a frame,
a transmission;
a differential assembly;
a driveshaft mechanically connecting the transmission and the differential assembly;
a vibration damper coupled for rotation with the driveshaft, the vibration damper including one or more fluid pockets;
a reactive fluid arranged in the one or more fluid pockets, the reactive fluid being configured to undergo a property change upon being exposed to a selected force; and
a force producing mechanism fixedly mounted relative to the vibration damper, the force producing mechanism being operable to selectively produce the selected force.

12. The vehicle according to claim 11, wherein the one or more fluid pockets comprises a plurality of discrete fluid pockets.

13. The vehicle according to claim 12, wherein the plurality of discrete fluid pockets are arranged in an annular array about the vibration damper.

14. The vehicle according to claim 12, wherein the vibration damper includes a first portion formed out of a first material, a second portion formed out of a second material, and a third portion formed from a third material, the second material being distinct from at least one of the first material and the third material.

15. The vehicle according to claim 14, wherein the second portion is disposed between the first portion and the third portion.

16. The vehicle according to claim 14, wherein the second material is distinct from each of the first material and the third material.

17. The vehicle according to claim 14, wherein the first material is the same as the third material.

18. The vehicle according to claim 14, wherein the second material comprises an elastomeric material.

19. The vehicle according to claim 11, wherein the reactive fluid comprises a magnetorheological fluid.

20. The vehicle according to claim 19, wherein the force producing mechanism comprises an electromagnet.
